(19) United States
(12) Patent Application Publication
(10) Pub. No.: US 2025/0191264 A1
(43) Pub. Date: Jun. 12, 2025

(54) METHOD AND ELECTRONIC DEVICE FOR DISPLAYING PARTICULAR USER

(71) Applicant: SAMSUNG ELECTRONICS CO., LTD., Suwon-si (KR)

(72) Inventors: Ambati VENKATESH, Bengaluru (IN); Jagadeesh Kumar MALLA, Bengaluru (IN); Pavan SUDHEENDRA, Bengaluru (IN); Nanda Nandan NANDA, Bengaluru (IN); Ritik Kumar AGRAHARI, Bengaluru (IN); Bharath Kameswara SOMAYAJULA, Bengaluru (IN); Nitin KAMBOJ, Bengaluru (IN); Avinav GOEL, Bengaluru (IN)

(73) Assignee: SAMSUNG ELECTRONICS CO., LTD., Suwon-si (KR)

(21) Appl. No.: 19/050,868

(22) Filed: Feb. 11, 2025

Related U.S. Application Data
(63) Continuation of application No. PCT/IB2023/058121, filed on Aug. 21, 2023.

(30) Foreign Application Priority Data
Aug. 13, 2022 (IN) 202241027704
Aug. 1, 2023 (IN) 202241027704

(51) Int. Cl. G06T 11/60; G06F 16/53; G06T 5/60; G06V 10/26; G06V 10/82; G06V 40/16; G06V 40/50

(52) U.S. Cl. CPC G06T 11/60; G06F 16/53; G06T 5/60; G06V 10/26; G06V 10/82; G06V 40/166; G06V 40/171; G06V 40/172; G06V 40/50; G06T 2207/20084; G06T 2207/30201

(57) ABSTRACT

A method and electronic device for displaying particular user are provided. The method includes capturing, using a camera, one or more input image frames including the user, determining pixels associated with the user, extracting a plurality of features of the user, weighting each of the features based on an amount of information corresponding each of the plurality of features, generating identity information for the user based on the weighted plurality of features, determining whether the generated identity information matches with at least one identity information stored in a database, and displaying the plurality of pixels associated with the user when the generated identity information matches with the at least one identity information in the database.

### CROSS REFERENCE TO RELATED APPLICATION

This application is a continuation of International Application No. PCT/IB2023/058121, filed on Aug. 11, 2023, which claims foreign priority to Indian Provisional Patent Application 202241027704, filed on Aug. 13, 2022, and Indian Patent Application 202241027704, filed on Jul. 1, 2023, the contents of which are incorporated herein by reference in their entireties.

### BACKGROUND

### 1. Field

The present disclosure relates to an electronic device, and more particularly to a method and electronic device for displaying particular user by an electronic device.

### 2. Description of Related Art

Video conferencing has been gaining widespread attention, especially in the consumer market. In the video conferencing, maintaining privacy is an important consideration, especially when it comes to protecting confidential or sensitive information displayed in the background.

The related art systems replace or hide the background for a user to maintain their privacy during these calls. However, the related art systems are not able to selectively hide persons in the background as shown in FIG. 2B.

In another related art system, the person in the background is identified as being in the background based on their distance from a camera as shown in FIG. 3 or based on the size of a face of the user as shown in FIG. 3. However, the person in the background is identified as foreground or person of interest when the person come close to the camera; this affects the privacy of the user.

Thus, it is desired to address the above-mentioned disadvantages or other shortcomings, or at least provide a useful alternative to display the person of interest.

### SUMMARY

Provided are a method and electronic device for displaying particular user. According to an aspect of the disclosure, a method for displaying a particular user and being performed by an electronic device, includes: capturing, using a camera of the electronic device, at least one input image frame including at least one user; determining, from the at least one input image frame, a plurality of pixels associated with the at least one user; extracting a plurality of features of the at least one user based on the plurality of pixels associated with the at least one user; weighting each of the plurality of features based on an amount of information corresponding each of the plurality of features; generating identity information corresponding to the at least one user based on the weighted plurality of features; determining whether the generated identity information matches at least one identity information stored in a database, wherein the at least one identity information includes a plurality of identities associated with a plurality of authorized users; and displaying the plurality of pixels associated with the at least one user based on determining that the generated identity information matches the at least one identity information in the database.

The method may further include performing a function corresponding to at least one of masking, filtering, and blurring the plurality of pixels associated with the at least one user based on determining that the generated identity information does not match the at least one identity information in the database.

The plurality of features may include at least one of information, indicating facial cues associated with the at least one user, and information indicating non-facial cues associated with the at least one user.

The at least one of the information, indicating facial cues associated with the at least one user, and the information, indicating non-facial cues associated with the at least one user, may include at least one of clothing, color, texture, style, body size, hair, face, pose, position, and viewpoint.

Displaying the plurality of pixels associated with the at least one user, may include: determining at least one output image frame for displaying the plurality of pixels associated with the at least one user; determining at least one visual effect to be applied to the at least one output image frame; determining at least one background frame using the at least one visual effect; determining at least one modified output image frame by merging the at least one output image frame and the at least one background frame; and displaying the at least one modified output image frame.

Determining the plurality of pixels associated with the at least one user, may include: segmenting the plurality of pixels associated with the at least one user from the at least one input image frame; and generating at least one pixel map including the segmented plurality of pixels associated with the at least one user.

The method may further include capturing, using the camera of the electronic device, at least one input image frame including the at least one user; selecting the at least one user based on at least one of user selection, size of face of the at least one user, distance of the at least one user from the electronic device and suggestions for selection; determining the plurality of pixels associated with the selected at least one user; extracting the plurality of features of the at least one user based on the plurality of pixels associated with the at least one user; weighting each of the plurality of features based on the amount of information associated with the corresponding feature of the plurality of features; generating the identity information corresponding to the at least one user based on the weighted plurality of features; and registering the identity information corresponding to the at least one user in the database, wherein registering the identity information of the at least one user in the database enables at least one of identification and authentication of the at least one user, wherein the database stores identities of the plurality of authorized users.

The method may further include determining that the at least one user is authorized to appear in a media associated with the at least one input image frame based on the generated identity information of the at least one user matching with the at least one identity information in the database; and displaying the plurality of pixels associated with the at least one user in the media on determining that the user is authorized to appear in the media.

The identity information corresponding to the at least one user may be generated using at least one deep neural network (DNN) model.

The amount of information associated with the corresponding feature of the plurality of features comprises at least one of a face direction, a color of texture, a distance from camera, a focus towards camera, and a presence of obstacles in the face.

According to an aspect of the disclosure, an electronic device for displaying particular user, includes: a memory; a processor; a display controller coupled with the memory and the processor, configured to: capture, using a camera, at least one input image frame including at least one user; determine, from the at least one input image frame, a plurality of pixels associated with the at least one user; extract a plurality of features of the at least one user based on the plurality of pixels associated with the at least one user; weight each of the plurality of features based on an amount of information corresponding each of the plurality of features; generate identity information corresponding to the at least one user based on the weighted plurality of features; determine whether the generated identity information matches with at least one identity information stored in a database, wherein the at least one identity information includes a plurality of identities associated with a plurality of authorized users; and display the plurality of pixels associated with the at least one user based on the generated identity information matching with the at least one identity information in the database.

The processor may be further configured to perform a function corresponding to at least one of masking, filtering, and blurring the plurality of pixels associated with the at least one user based on determining that the generated identity information does not match the at least one identity information in the database.

The identity information may be a feature vector.

The plurality of features may include at least one of information, indicating facial cues associated with the at least one user, and information indicating non-facial cues associated with the at least one user.

The at least one of the information, indicating facial cues associated with the at least one user, and the information, indicating non-facial cues associated with the at least one user, for determining the plurality of features may include at least one of clothing, color, texture, style, body size, hair, face, pose, position, and viewpoint.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A illustrates a video conferencing with backgrounds, according to the related art;

FIG. 1B illustrates a video conferencing with backgrounds, according to the related art;

FIG. 2A illustrates hiding of background in the video conferencing, according to the related art;

FIG. 2B illustrates hiding of background in the video conferencing, according to the related art;

FIG. 3 illustrates hiding of users in the background based on face size, according to the related art;

FIG. 4 illustrates hiding of users in the background based on distance of the users from an electronic device, according to the related art;

FIG. 5 is a diagram illustrating tracking of face using face feature vectors, according to the related art;

FIG. 6 is a diagram illustrating facial expression recognition and tracks facial features, according to the related art;

FIG. 7 is a diagram illustrating graph cut segmentation based on user touch facial expression recognition and tracks facial features, according to the related art;

FIG. 8A is a diagram illustrating matched frames based on user touch input, according to the related art;

FIG. 8B is a diagram illustrating matched frames based on user touch input, according to the related art;

FIG. 9A is a diagram illustrating segmentation based on user interest region and user touch points, according to the related art;

FIG. 9B is a diagram illustrating segmentation based on user interest region and user touch points, according to the related art;

FIG. 10 is a block diagram of an electronic device for displaying particular user, according to one or more embodiments;

FIG. 11 is a flowchart illustrating method for displaying particular user by the electronic device, according to one or more embodiments;

FIG. 12 is a sequence diagram illustrating a registration and recognition of one or more users, according to one or more embodiments;

FIG. 13 is a diagram illustrating tracking of the registered one or more users, according to one or more embodiments;

FIG. 14A is diagram illustrating determination of humans in an input frame, according to one or more embodiments;

FIG. 14B is diagram illustrating determination of humans in an input frame, according to one or more embodiments;

FIG. 14C is diagram illustrating determination of humans in an input frame, according to one or more embodiments;

FIG. 15 is a flowchart illustrating method for identifying desired user pixels, according to one or more embodiments;

FIG. 16 is a diagram illustrating segmentation and identity entity generation, according to one or more embodiments;

FIG. 17 illustrates shifting of focus across registered profiles, according to one or more embodiments;

FIG. 18 illustrates shifting of focus across registered profiles, according to one or more embodiments;

FIG. 19 is a diagram illustrating a method to reduce a difference between model prediction and annotated ground truth of the input image, according to one or more embodiments;

FIG. 20 is a diagram illustrating identity generation based on features visualization, according to one or more embodiments;

FIG. 21 is a flowchart illustrating training of identity decoder module, according to one or more embodiments;

FIG. 22 is a diagram illustrating data packets containing samples from the database for giving inputs to the identity decoder module, according to one or more embodiments;

FIG. 23A is a diagram illustrates different attention regions and different weighted combination for appearance variation, according to one or more embodiments;

FIG. 23B is a diagram illustrates different attention regions and different weighted combination for appearance variation, according to one or more embodiments;

FIG. 23C is a diagram illustrates different attention regions and different weighted combination for appearance variation, according to one or more embodiments;

FIG. 23D is a diagram illustrates different attention regions and different weighted combination for appearance variation, according to one or more embodiments;

FIG. 24 is a diagram illustrating manual registration of the one or more users, according to one or more embodiments;

FIG. 25 is a diagram illustrating automatic registration of the one or more users, according to one or more embodiments;

FIG. 26 is a diagram illustrating suggestion based registration of the one or more users, according to one or more embodiments;

FIG. 27 is a flowchart illustrating registration process using identity entity generator, according to one or more embodiments;

FIG. 28 is a flowchart illustrating automatic instance recognition and filtering based on registered user, according to one or more embodiments;

FIG. 29 is a diagram illustrating registration of one or more user and matching the input image frame with the register user, according to one or more embodiments;

FIG. 30 is a diagram illustrating weighting of the one or more users and matching the input image frame with the register user, according to one or more embodiments;

FIG. 31 is a diagram illustrating a method for applying bokeh in the input image frame for the non-registered user, according to one or more embodiments;

FIG. 32 is a diagram illustrating auto focus based on person of interest, according to one or more embodiments;

FIG. 33 is a diagram illustrating hiding of background details for the registered user using blur/background effect, according to one or more embodiments; and

FIG. 34 is a diagram illustrating a personalization of gallery photos, according to one or more embodiments.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein provide a method for displaying particular user by an electronic device. The method includes capturing, using a camera of the electronic device, one or more input image frames including one or more users. Further, the method includes determining, by the electronic device, a plurality of pixels associated with the one or more users. Further, the method includes extracting, by the electronic device, a plurality of features of the one or more users based on the plurality of pixels associated with the one or more users.

Further, the method includes weighting, by the electronic device, each of the plurality of features based on an amount of information corresponding each of the plurality of features.

The method includes assigning, by the electronic device, a weight corresponding to the each of the plurality of features to the each of the plurality of features. For example, the plurality of features may include a first feature and a second feature. The method further assigning a first weight corresponding to the first feature and assigning a second weight corresponding to the second feature. The first weight may be different from the second weight.

Further, the method includes generating, by the electronic device, identity information corresponding to the one or more users based on the weighted plurality of features.

Further, the method includes determining, by the electronic device, whether the generated identity information matches with one or more identities in a database, wherein the database includes a plurality of identities associated with a plurality of authorized users.

The method includes determining, by the electronic device, whether the generated identity information corresponds to one or more identities in a database.

Further, the method includes displaying, by the electronic device, the plurality of pixels associated with the one or more users when the generated identity information matches with the one or more identities in the database.

The method includes displaying, by the electronic device, the plurality of pixels corresponding to the one or more users based on the generated identity information matching with the one or more identities in the database.

The method includes displaying, by the electronic device, the plurality of pixels associated with the one or more users when the generated identity information corresponds to the one or more identities in the database.

The method includes displaying, by the electronic device, the plurality of pixels associated with the one or more users based on the generated identity information being included in in the one or more identities in the database.

Accordingly, the embodiments herein provide the electronic device for displaying particular user, includes: a memory, a processor, and a display controller coupled with the memory and the processor. The display controller is configured to capture the one or more input image frames including one or more users using the camera. Further, the display controller is configured to determine the plurality of pixels associated with the one or more users. Further, the display controller is configured to extract the plurality of features of the one or more users based on the plurality of pixels associated with the one or more users. Further, the display controller is configured to weight each of the plurality of features based on the amount of information associated with the corresponding feature of the plurality of features. Further, the display controller is configured to generate the identity information corresponding to the one or more users based on the weighted plurality of features. Further, the display controller is configured to determine whether the generated identity information matches with one or more identities in the database, wherein the database includes the plurality of identities associated with the plurality of authorized users. Further, the display controller is configured to display the plurality of pixels associated with the one or more users when the generated identity information matches with the one or more identities in the database. Further, the display controller is configured to display the plurality of pixels corresponding to the one or more users based on the generated identity information matching with the one or more identities in the database.

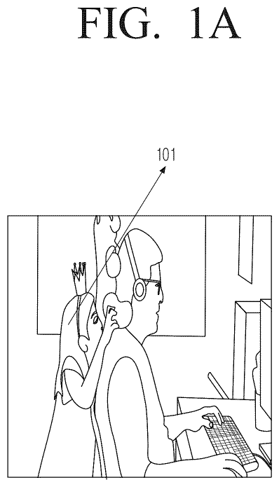

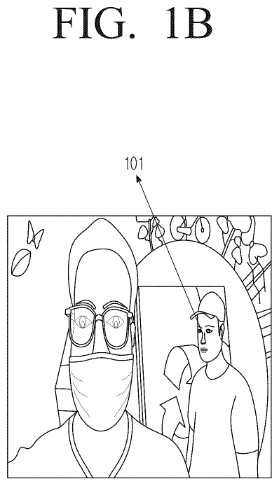

FIG. 1A and FIG. 1B illustrate scenarios of video conferencing with backgrounds, according to the related art.

In the recent past, related art systems and methods have provided features including replace and hide background corresponding to the one or more users to maintain privacy during the video conferencing. However, the related art systems and methods are not able to completely avoid persons, such as a background person 101, from coming into focus as shown in FIG. 1A and FIG. 1B. In the related art systems and methods, the background person is identified based on distance of the person from a camera. The related art systems and methods classify the background person as foreground or person of interest when the background person come close to the camera. The privacy of the user in such scenarios is affected by these “Unintentional Interruptions”.

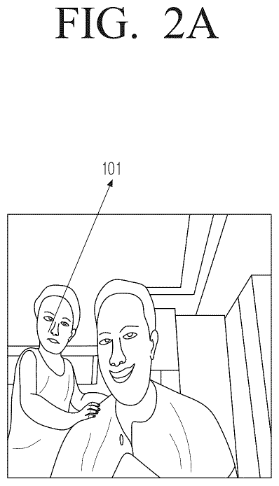

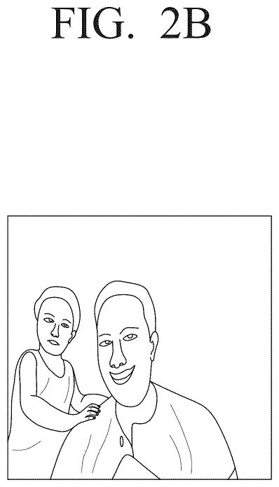

FIG. 2A and FIG. 2B illustrate a scenario of hiding a background in the video conferencing, according to the related art.

In FIG. 2A, the user and the background person 101 are captured during the video conferencing. The related art systems and methods remove the background as shown in FIG. 2B; however, the related art systems and methods are not able to selectively remove the background person 101.

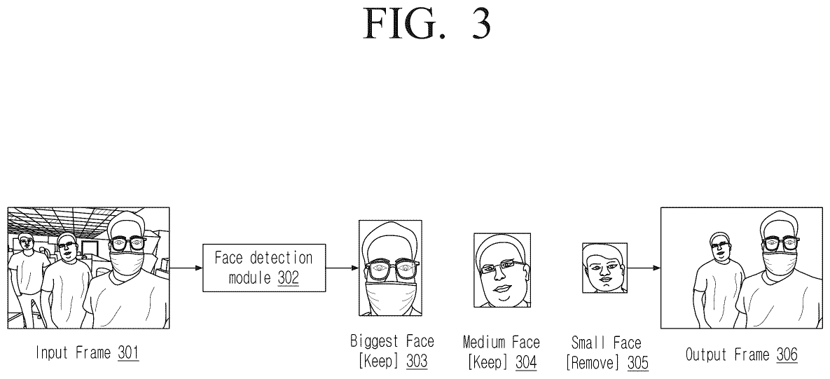

FIG. 3 illustrates hiding of users in background based on face size, according to the related art.

The related art system captures an input frame 301 using the camera. The related art system analyzes the input frame 301 using a face detection module 302 to provide an output frame 306. The related art system removes one background person but does not remove another background person from the input image frame, as the related art system kept the biggest face 303 and medium face 304 in the output frame 306 and removes the small face 305. Even the medium face 304 is an unwanted user, but the related art system considers the medium face 304 because of the size of the face. The related art system removes small face 305 assuming that the user is farther from the camera.

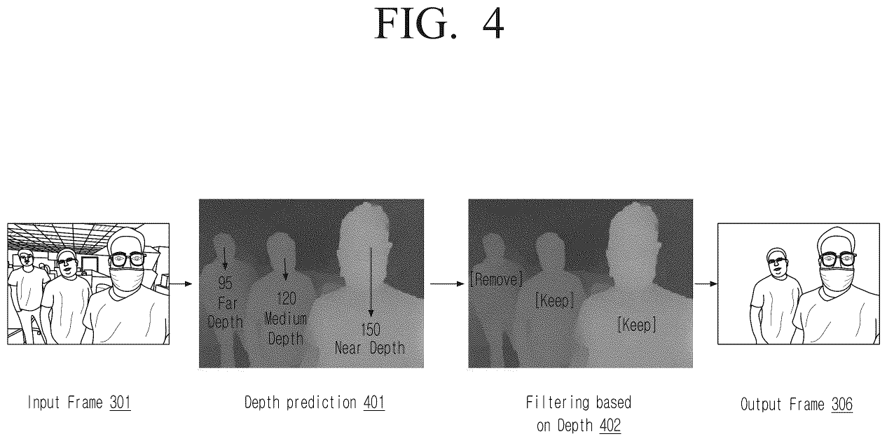

FIG. 4 illustrates hiding of users in the background based on distance of the users from the electronic device 1000, according to the related art.

The related art system captures an input frame 301 using the camera. The related art system analyzes the input frame 301 based on depth prediction 40 and filters 402 the input frame based on the depth to provide an output frame 306. The related art system filters instances that have farther depth from the camera.

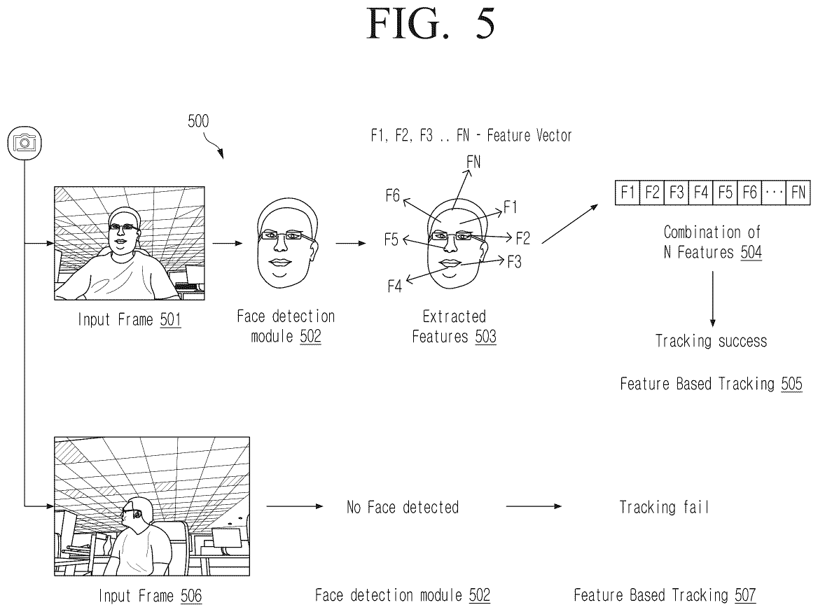

FIG. 5 is a diagram 500 illustrating tracking of the face using face feature vectors, according to the related art.

The related art system analyzes an input frame 501 using a face detection module 502. The face detection module 502 extracts (or obtains) features at 503. At 504, a combination of N features are provided from the extracted features and the combination of N features are used by the related art system for tracking the user. At 505, the related art system is successful in tracking the user.

In another scenario, the related art system analyzes an input frame 506 using the face detection module 502. At 507, the face detection module 502 not able to detect any face as the user turns away from the camera. At 508, the related art system failed in tracking the user as the user turns away from the camera.

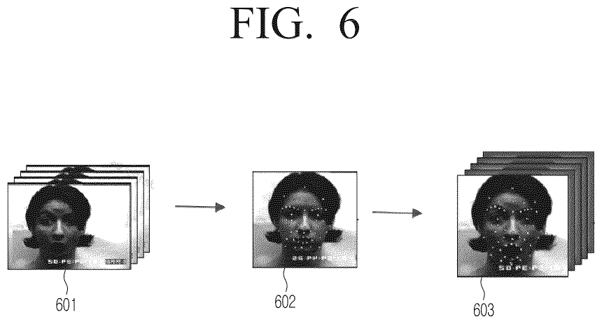

FIG. 6 is a diagram illustrating facial expression recognition and tracks facial features, according to the related art.

The related art system focuses on facial expression recognition and tracks facial features over the input image or video frames, such as frame 601, frame 602, and frame 603. The related art system uses fixed positional based landmark detection relying on face for extracting features for recognition. The related art system requires a face to be available for feature extraction. Unlike the related art system, the embodiments herein generate unique identity corresponding to the one or more users in the input image using a whole pixel information of the one or more users.

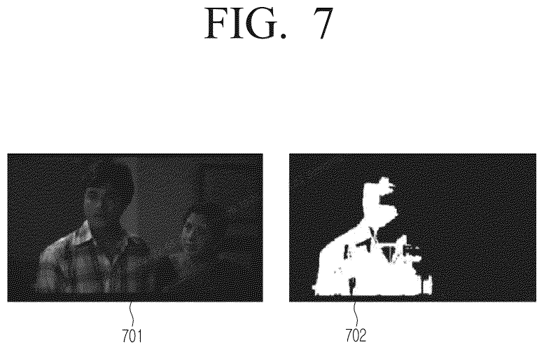

FIG. 7 is a diagram illustrating graph cut segmentation based on user touch facial expression recognition and tracks facial features, according to the related art.

The related art system utilizes graph cut segmentation that needs two-touch point, one at foreground point and another at background point in an input frame 701 to provide a segmented output frame 702. The graph cut segmentation is a traditional non-learning method, the segmentation is affected by color and strong edges in the input frame. Unlike related art systems, the embodiments of the disclosure are human centric and segment all humans in the scene with no dependency on touch points for segmentation.

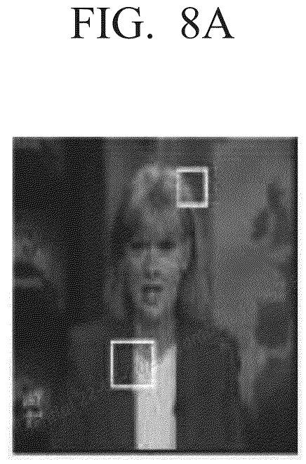

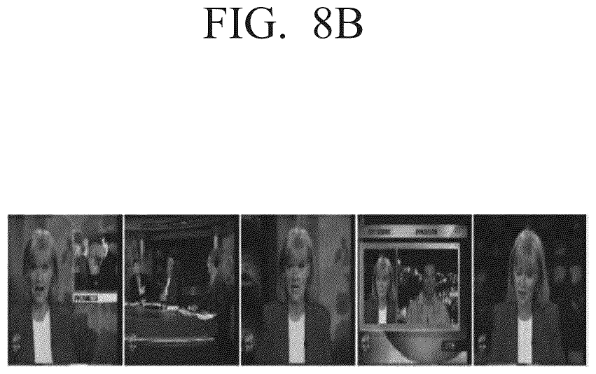

FIG. 8A and FIG. 8B are diagrams illustrating matched frames based on user touch input, according to the related art.

The related art system performs feature matching in three steps including segmentation of user pointed object from a key frames as shown in FIG. 8A, feature extraction of segmented object (color, edge and shape) and matching extracted features from video to retrieve frames as shown in FIG. 8 B. However in the related art system, when the person changes his visual attributes in a scene (e.g., changes clothes after some frames), the detection is affected. Unlike related art systems, the embodiments herein are human centric and segment all humans in the scene with no dependency on touch points for segmentation.

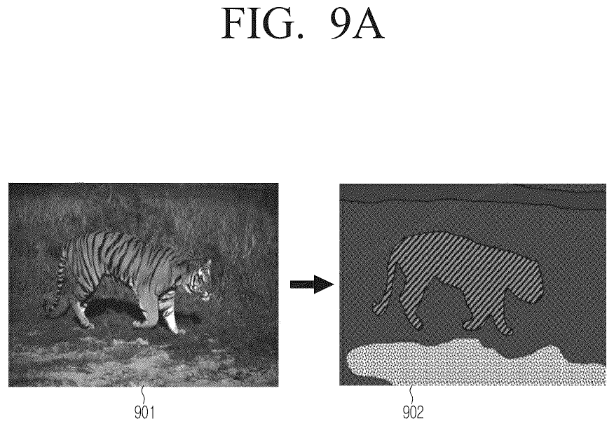

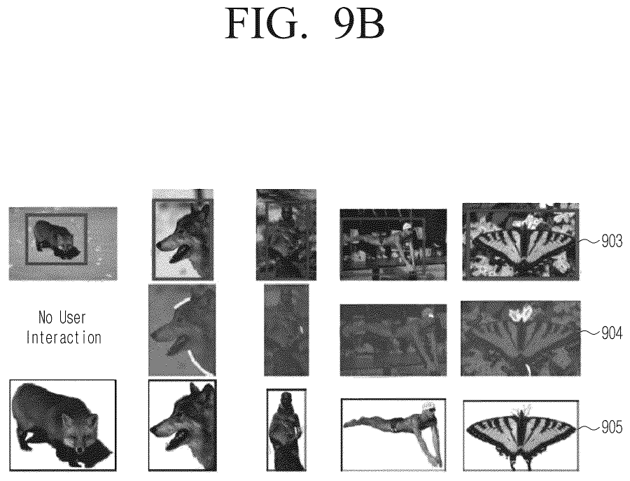

FIG. 9A and FIG. 9B are diagrams illustrating segmentation based on user interest region and user touch points, according to the related art.

The related art graph cut segmentation divides an input frame 901 image into segments 902 based on color and strong edges as shown in FIG. 9A.

In FIG. 9B, the user provides interest region boxes 903 and touch points 904. At 905, the input frame is divided into foreground and background segments based on the touch points. In related art systems, the accuracy is highly dependent on the provided touch points and may work relatively well enough only for simple images without complex backgrounds, wherein in complex images is images with color in foreground and background are similar. Unlike related art systems, the embodiments herein do not required any touch points from user for segmentation.

In some related art systems, walking patterns are used for authentication of the user. The related art system uses motion sensors (gyroscope) available on smartphone and generates motion signals. The generated motion signal is converted to images to generate feature vectors. The related art system requires dedicated hardware to generate feature vectors and relies upon activity-based sensors to generate motion signals. Unlike related art systems, the embodiments herein use a single visual frame for generating unique identity from the scene and authenticating the user

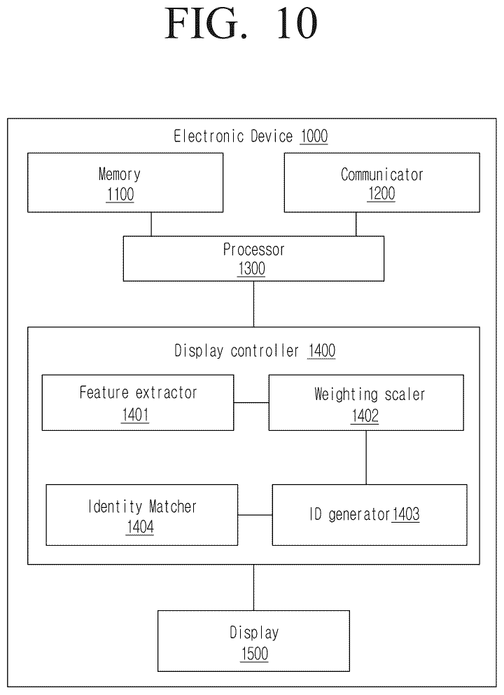

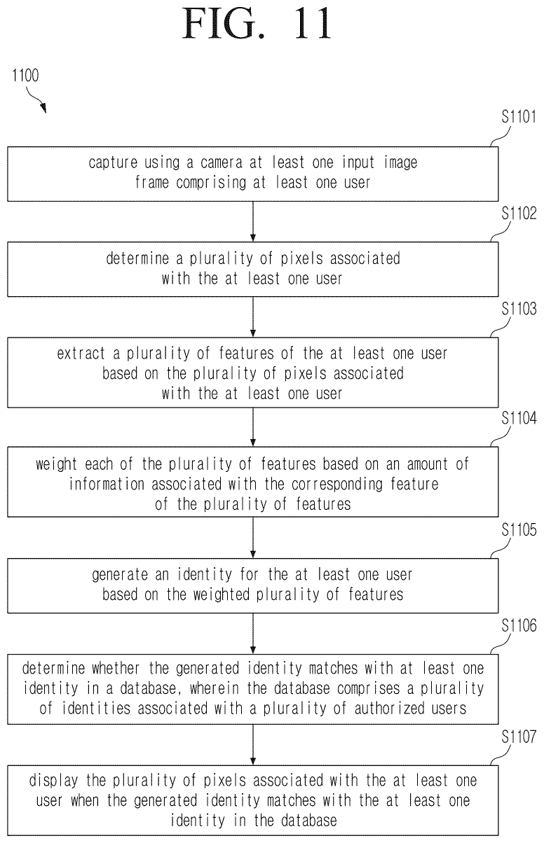

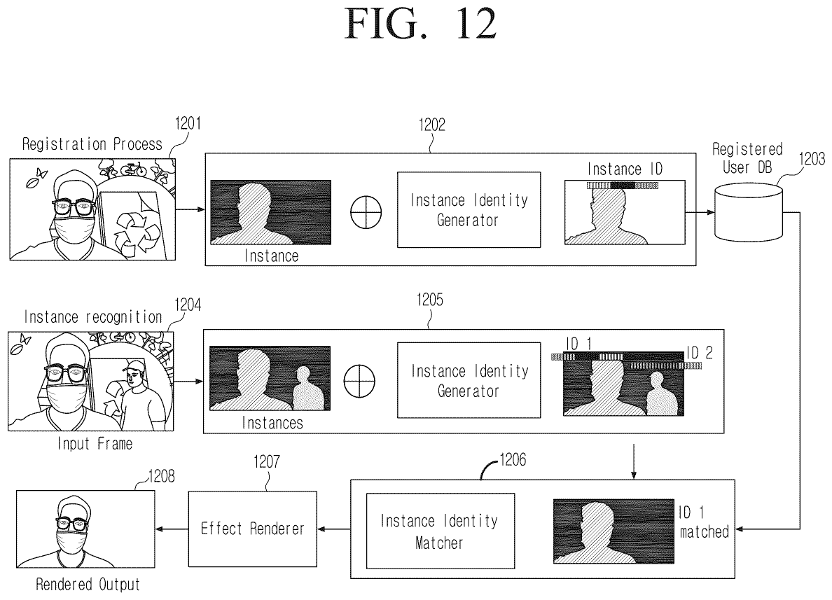

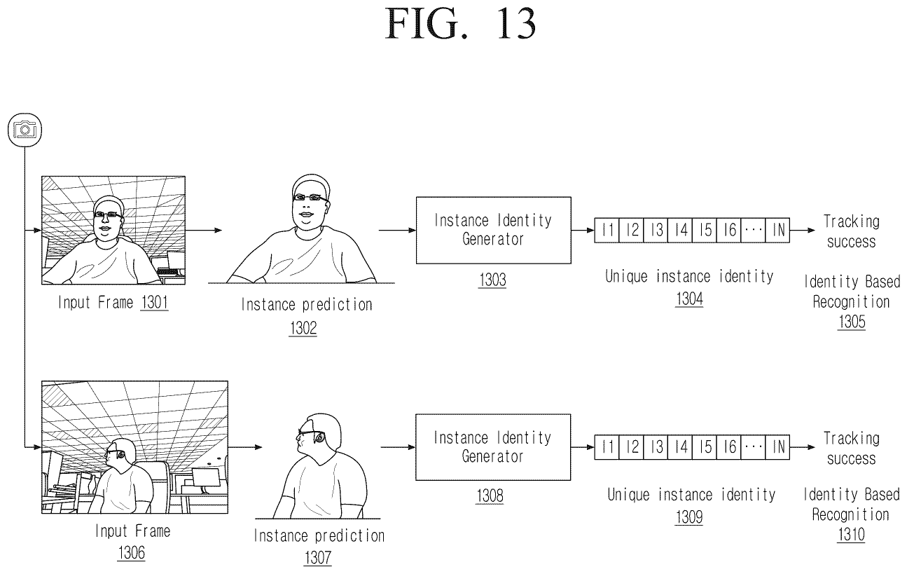

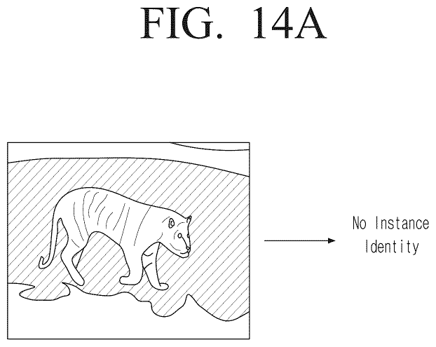

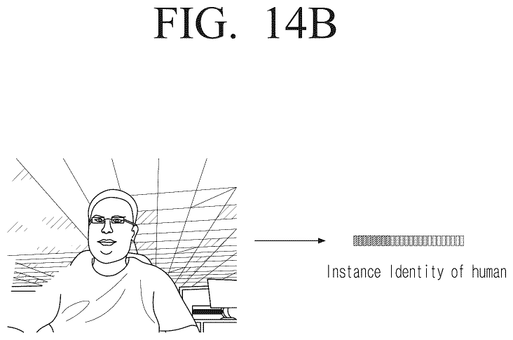

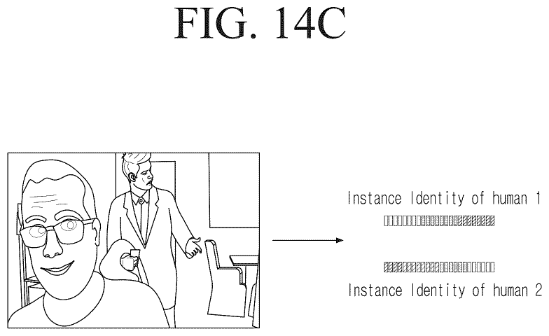

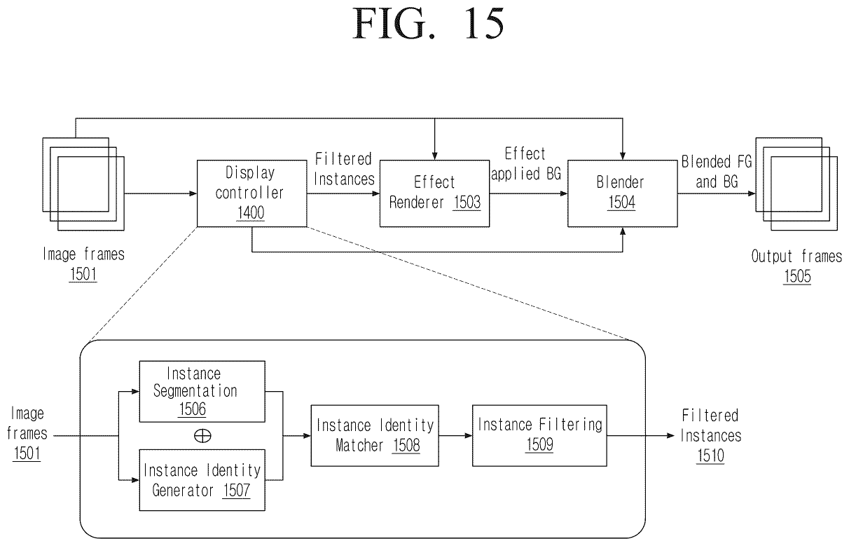

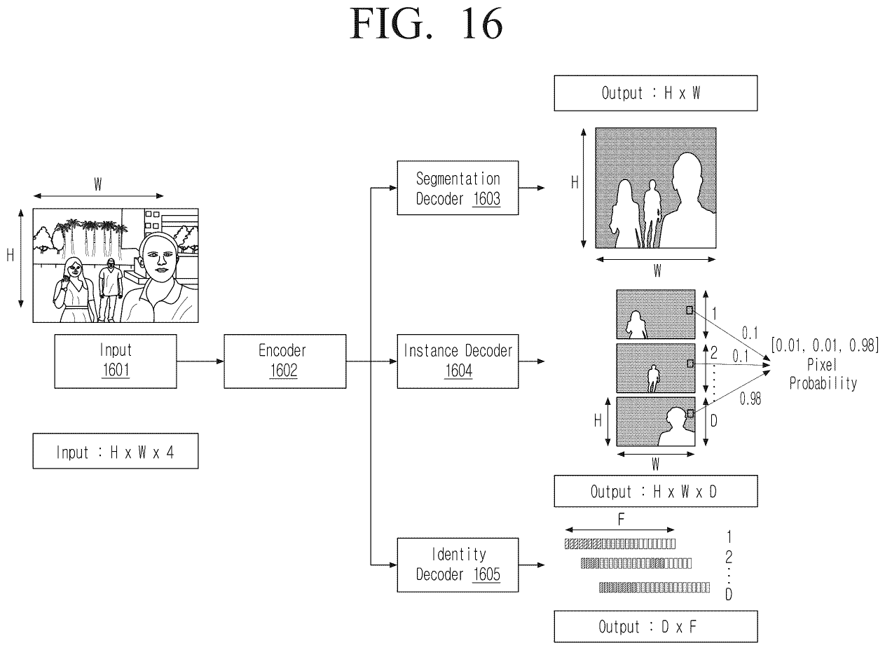

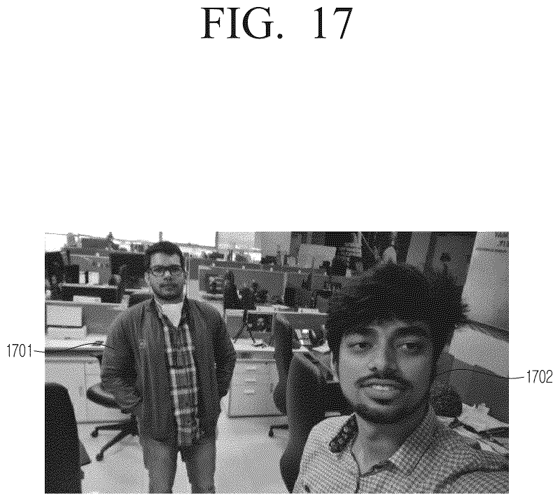

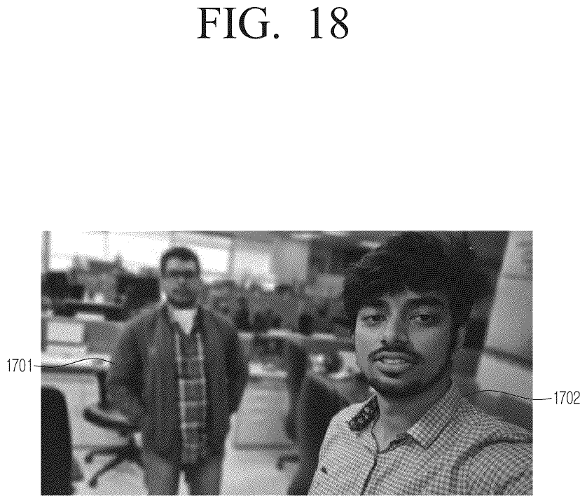

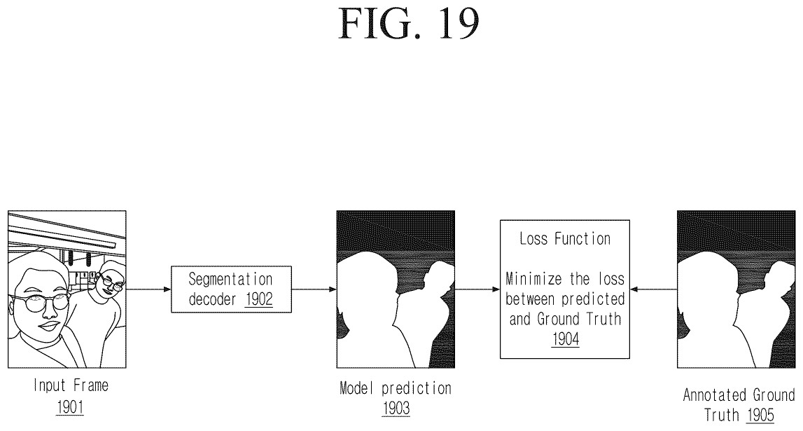

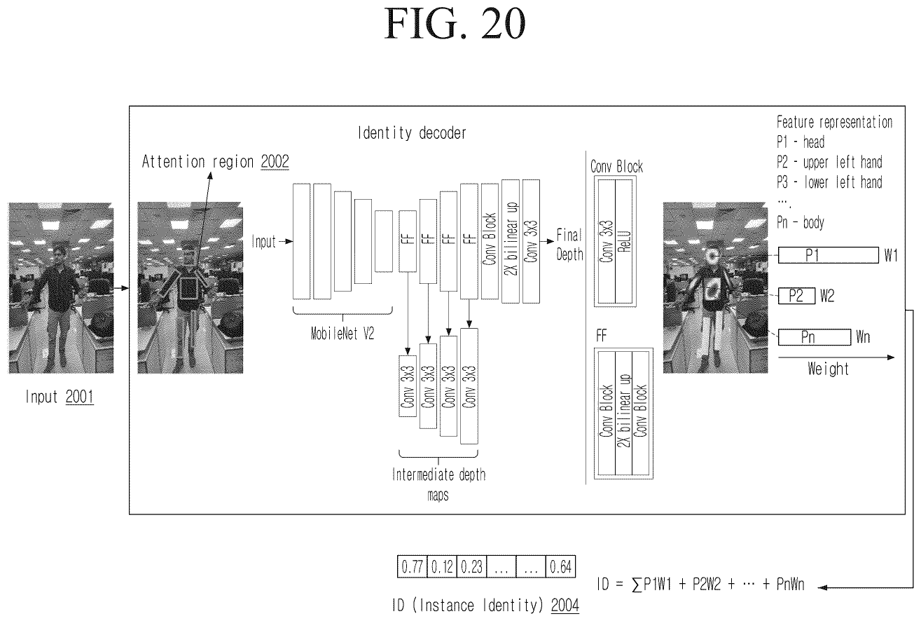

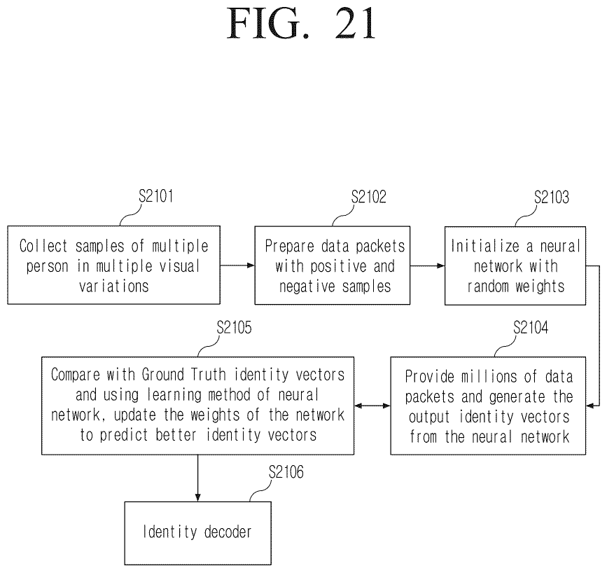

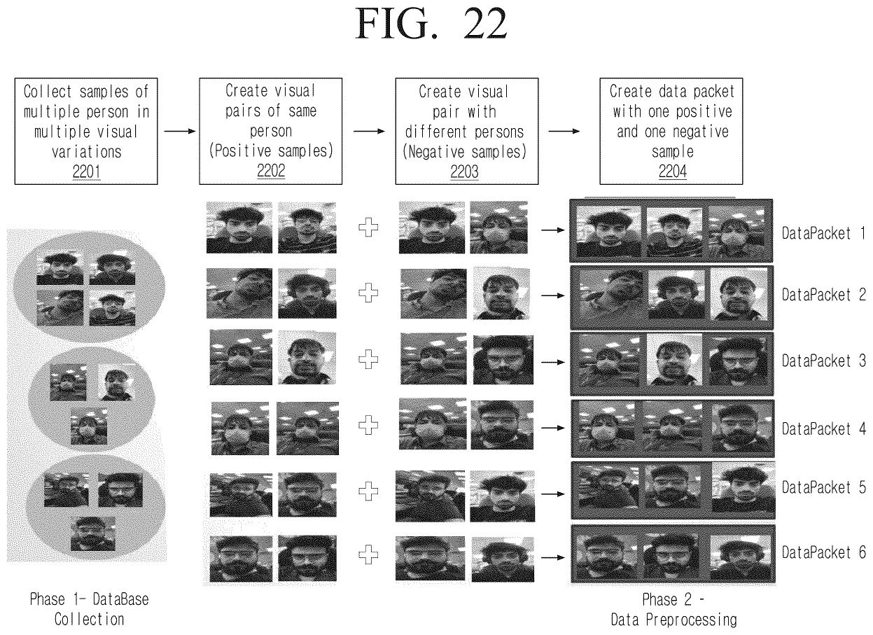

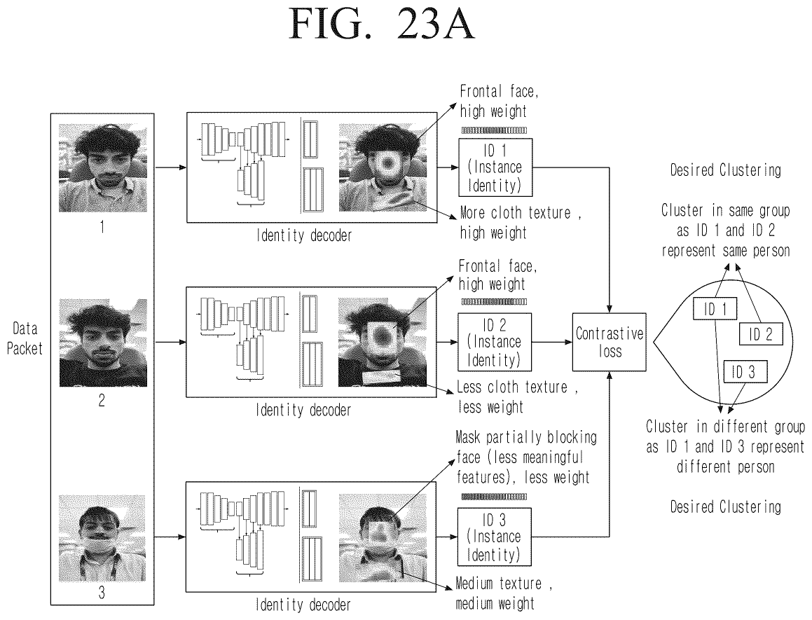

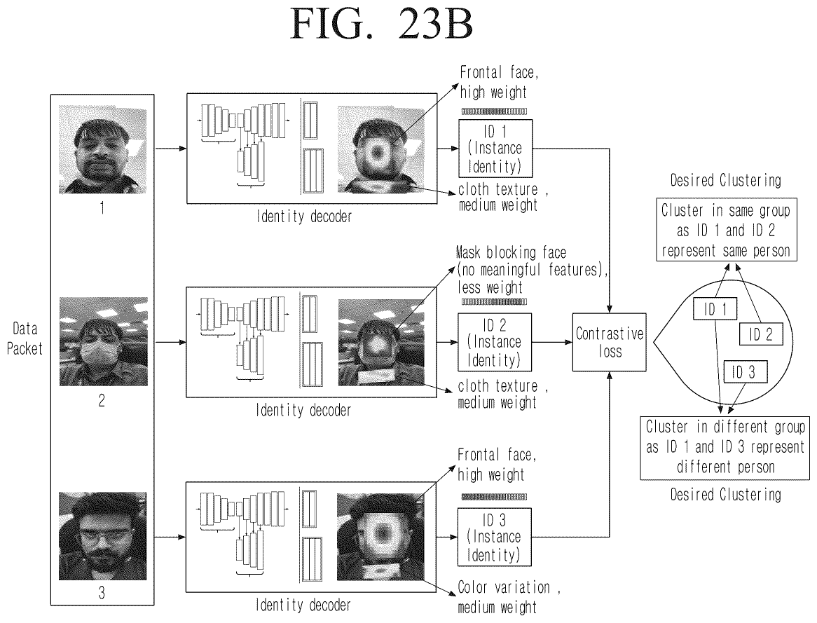

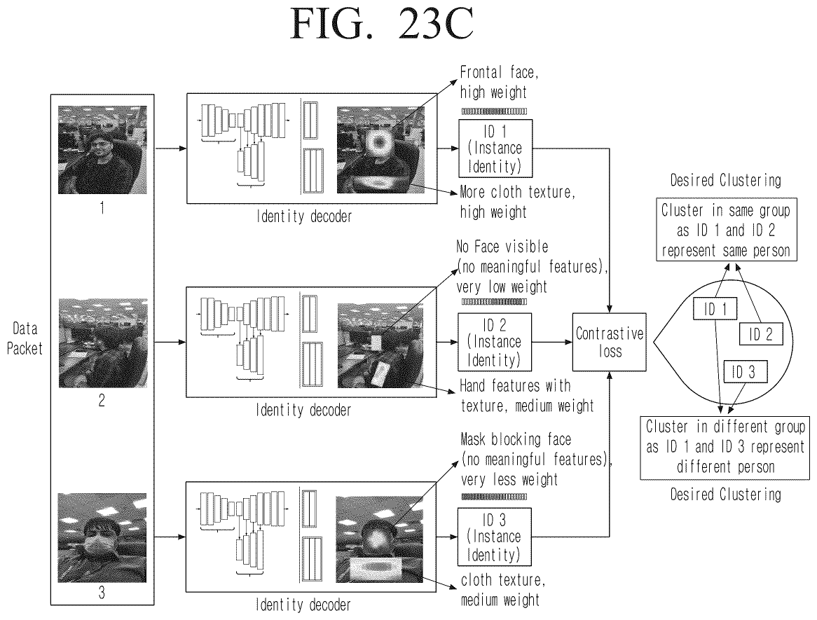

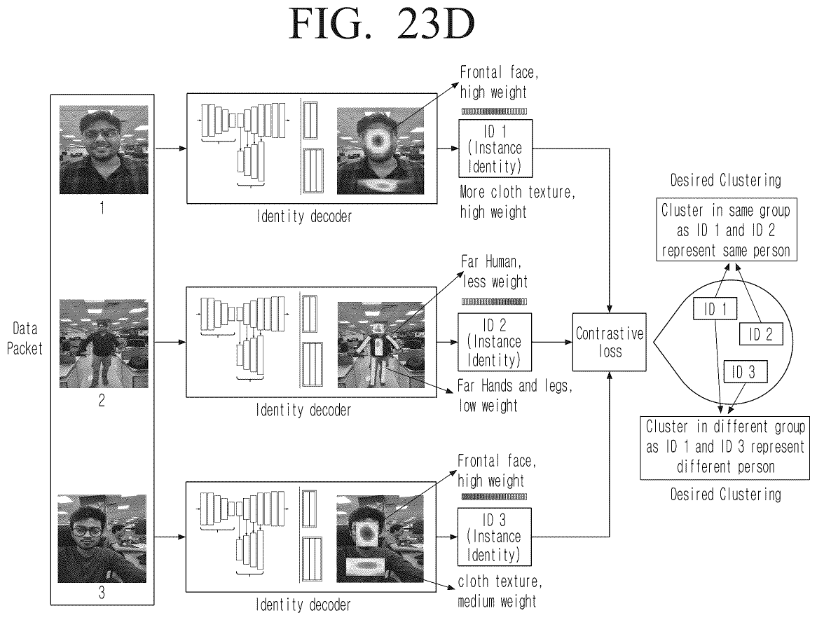

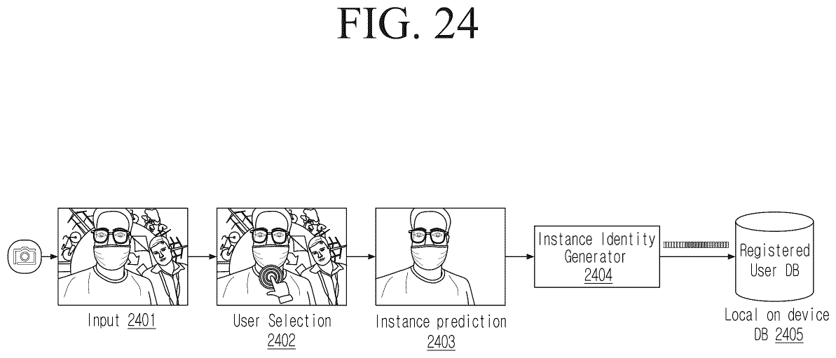

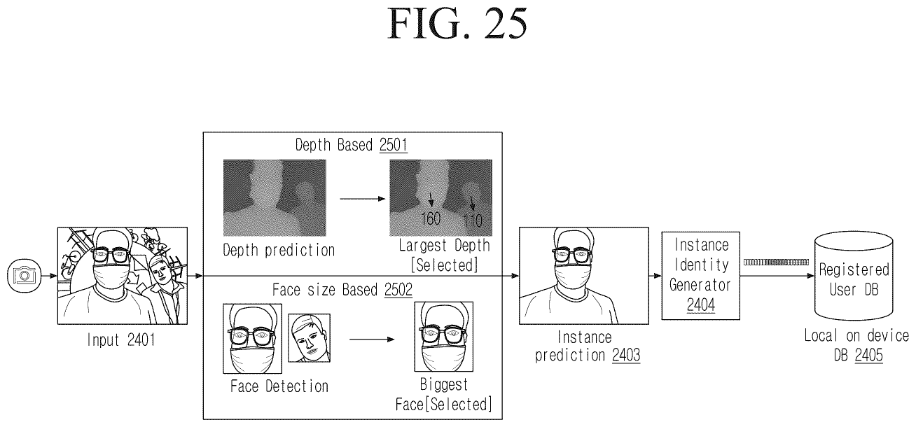

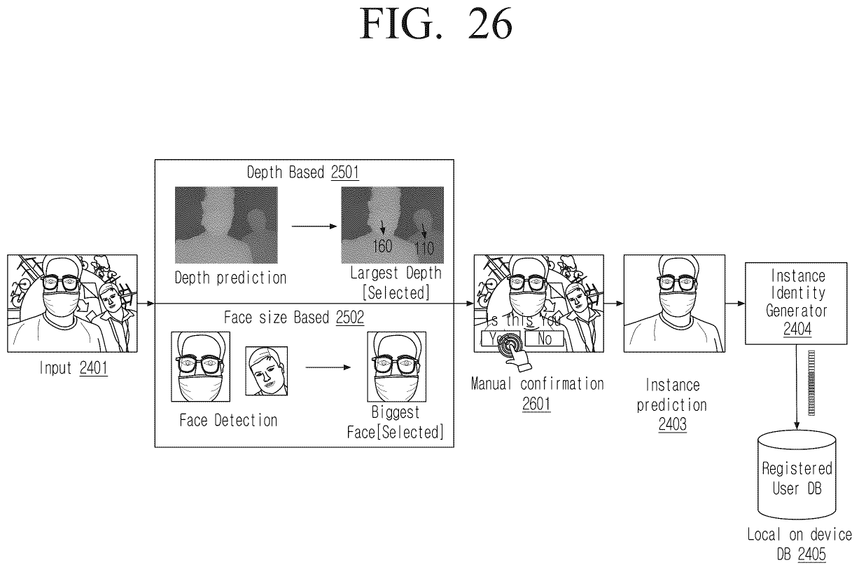

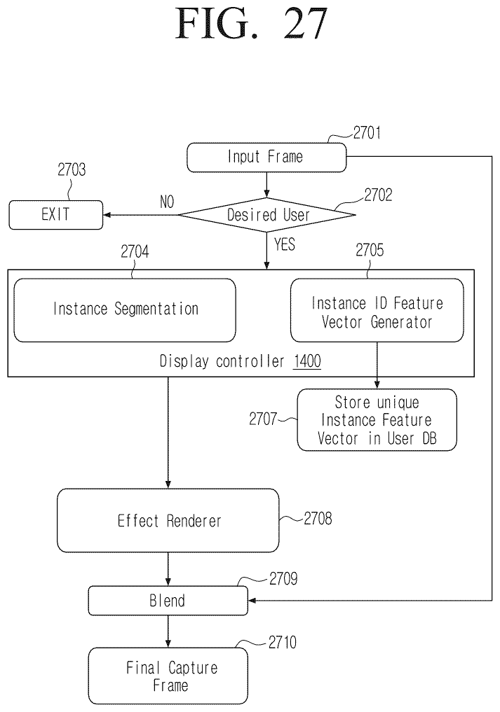

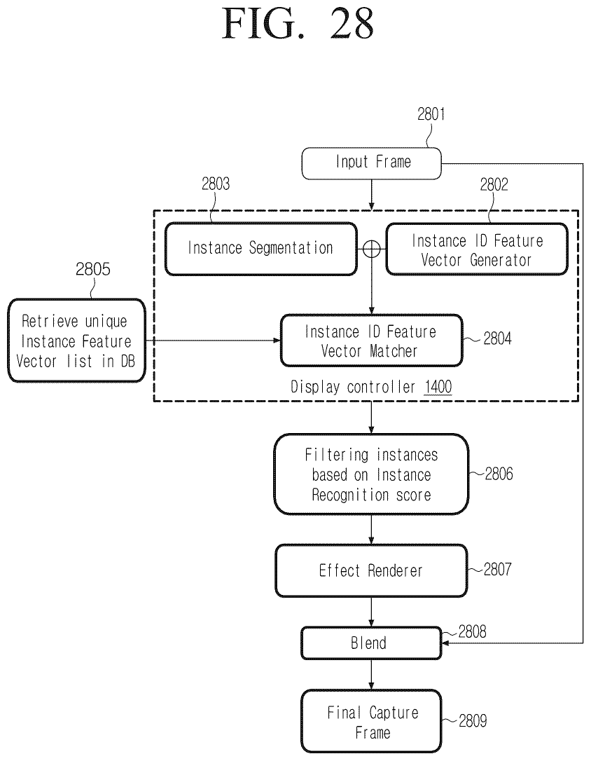

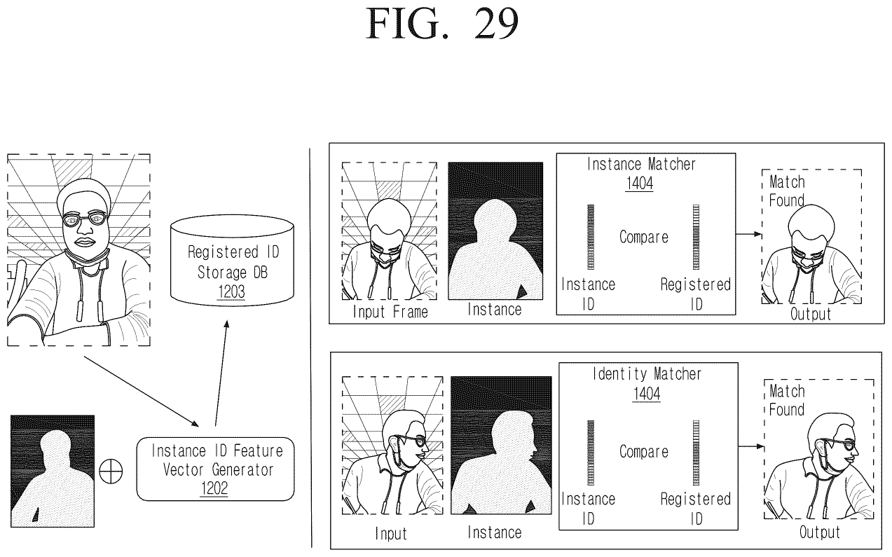

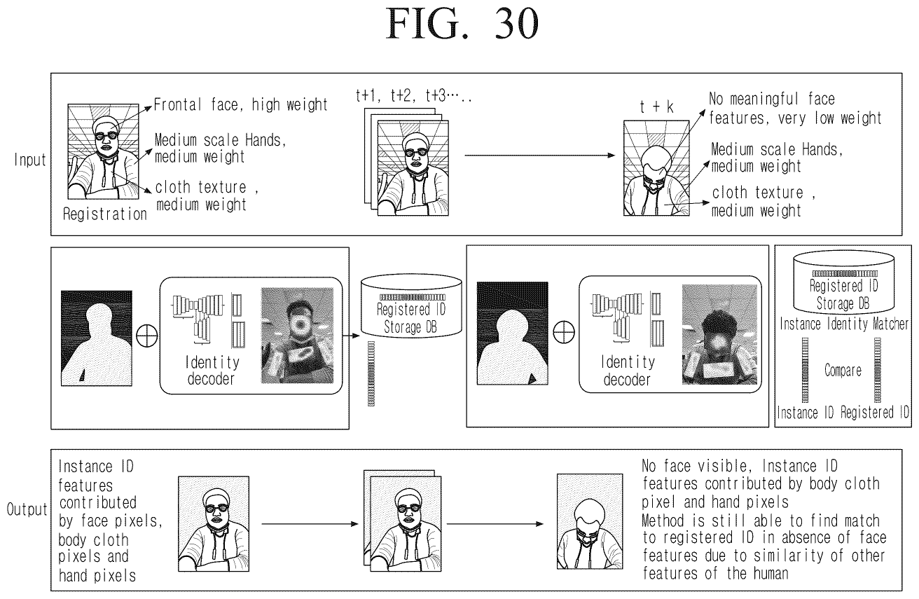

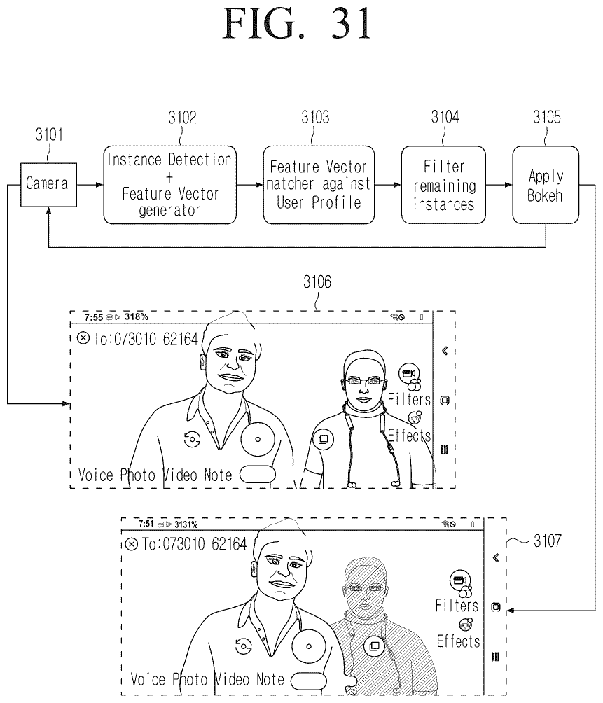

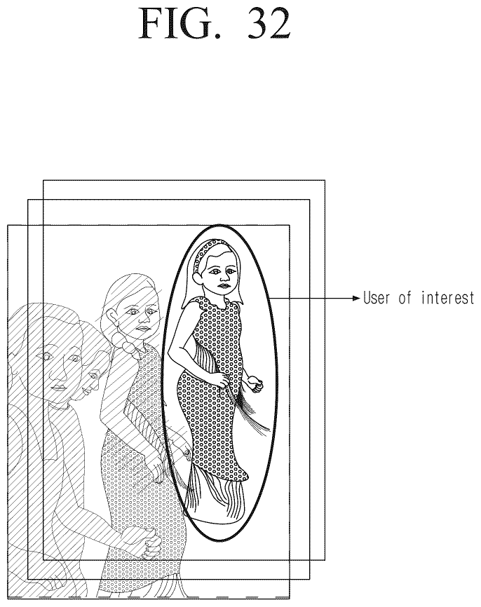

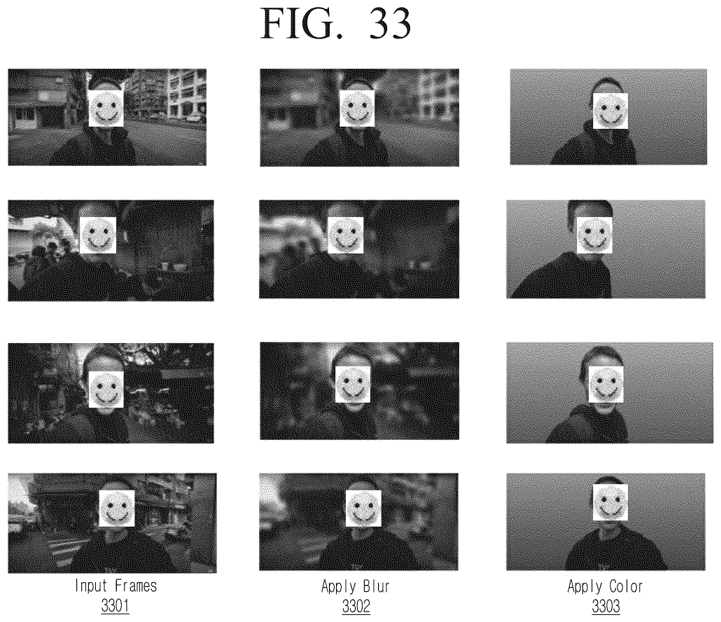

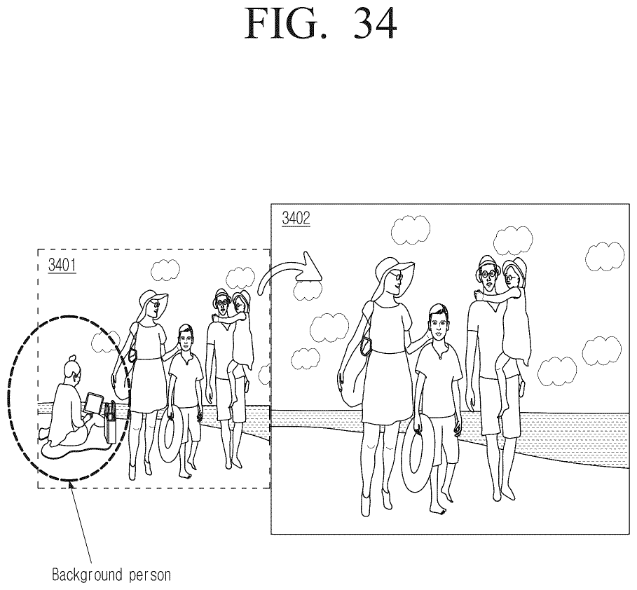

Referring now to the drawings and more particularly to FIG. 10, FIG. 11, FIG. 12, FIG. 13, FIG. 14A, FIG. 14B, FIG. 14C, FIG. 15, FIG. 16, FIG. 17, FIG. 18, FIG. 19, FIG. 20, FIG. 21, FIG. 22, FIG. 23A, FIG. 23B, FIG. 23C, FIG. 23D, FIG. 24, FIG. 25, FIG. 26, FIG. 27, FIG. 28, FIG. 29, FIG. 30, FIG. 31, FIG. 32, FIG. 33, and FIG. 34, where similar reference characters denote corresponding features consistently throughout the figure, these are shown example embodiments.

FIG. 10 is a block diagram of an electronic device 1000 for displaying particular user, according to one or more embodiments.

Referring to FIG. 10, examples of the electronic device 1000 include but are not limited to a laptop, a palmtop, a desktop, a mobile phone, a smartphone, Personal Digital Assistant (PDA), a tablet, a wearable device, an Internet of Things (IoT) device, a virtual reality device, a foldable device, a flexible device, an immersive system, etc.

In one or more embodiments, the electronic device 1000 includes a memory 1100, a processor 1300, a communicator 1200 and a display controller 1400.

The memory 1100 stores instructions for authentication method selection to be executed by the processor 1300. The memory 1100 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 1100 may, in some examples, be considered a non-transitory storage medium. The term “non-transitory” may indicate that the storage medium is not embodied in a carrier wave or a propagated signal. However, the term “non-transitory” should not be interpreted that the memory 1100 is non-movable. In some examples, the memory 1100 can be configured to store larger amounts of information than its storage space. In certain examples, a non-transitory storage medium may store data that can, over time, change (e.g., in Random Access Memory (RAM) or cache). The memory 1100 can be an internal storage unit or it can be an external storage unit of the electronic device 1000, a cloud storage, or any other type of external storage.

The processor 1300 is configured to execute instructions stored in the memory 1100. The processor 1300 may be a general-purpose processor 1300, such as a Central Processing Unit (CPU), an Application Processor (AP), or the like, a graphics-only processing unit such as a Graphics Processing Unit (GPU), a Visual Processing Unit (VPU) and the like. The processor 1300 may include multiple cores to execute the instructions.

The communicator 1200 is configured for communicating internally between hardware components in the electronic device 1000. Further, the communicator 1200 is configured to facilitate the communication between the electronic device 1000 and other devices via one or more networks (e.g. Radio technology). The communicator 1200 includes an electronic circuit specific to a standard that enables wired or wireless communication.

The processor 1300 is coupled with the display controller 1400 to perform the embodiment. The display controller 1400 includes a feature extractor 1401, a Weighting scaler 1402, an Identity Matcher 1404 and an ID generator 1403.

The feature extractor 1401 captures using a camera one or more input image frames comprising(including) one or more users. The feature extractor 1401 obtains one or more input image frames including one or more users.

The feature extractor 1401 determines a plurality of pixels associated with the one or more users and extracts a plurality of features of the one or more users based on the plurality of pixels associated with the one or more users

The weighting scaler 1402 weights each of the plurality of features based on an amount of information associated with the corresponding feature of the plurality of features and generates an identity corresponding to the one or more users based on the weighted plurality of features. The identity matcher 1404 determines whether the generated identity matches with at least one identity in a database, wherein the database comprises pre-stored the at least one identity information including a plurality of identities associated with a plurality of authorized users. The ID generator 1403 displays the plurality of pixels associated with the one or more users when the generated identity matches with the at least one identity pre stored in the database.

In one or more embodiments, the display controller 1400 performs function corresponding to at least one of masking, filtering, or blurring the plurality of pixels associated with the one or more users when the generated identity does not match with the at least one identity pre stored in the database.

In one or more embodiments, the display controller 1400 performs function corresponding to at least one of masking, filtering, or blurring the plurality of pixels associated with the one or more users based on the generated identity not being included in the at least one identity pre stored in the database.

In one or more embodiments, the identity is a feature vector.

In one or more embodiments, the plurality of features comprises at least one of information indicating facial cues and information indicating non-facial cues associated with the one or more users. The information indicating facial cues may be described as first information indicating facial cues. The information indicating non-facial cues may be described as second information indicating non-facial cues.

In one or more embodiments, the at least one of the information indicating facial cues and the information indicating non-facial cues associated with the one or more users for determining (or identifying) the plurality of features comprises at least one of clothing, color, texture, style, other id related cues, body size, hair, face, pose, position, and viewpoint.

In one or more embodiments, the display controller 1400 determines at least one output image frame for displaying the plurality of pixels associated with the one or more users. Further, the display controller 1400 determines at least one visual effect to be applied to the at least one output image frame. Further, the display controller 1400 determines at least one background frame using the at least one visual effect. Further, the display controller 1400 determines at least one modified output image frame by merging the at least one output image frame and the at least one background frame. Further, the display controller 1400 displays the at least one modified output image frame.

In one or more embodiments, the display controller 1400 segments the plurality of pixels associated with the one or more users from the at least one input image frame. The display controller 1400 generates at least one pixel map including the segmented plurality of pixels associated with the one or more users.

In one or more embodiments, the display controller 1400 captures using the camera of the electronic device 1000, at least one input image frame including the one or more users. The display controller 1400 select the one or more users based on at least one of user selection, size of face of the one or more users, distance of the one or more users from the electronic device 1000 and suggestions for selection. The display controller 1400 determines the plurality of pixels associated with the selected one or more users. The display controller 1400 extracts the plurality of features of the one or more users based on the plurality of pixels associated with the one or more users. The display controller 1400 weights each of the plurality of features based on the amount of information associated with the corresponding feature of the plurality of features. The display controller 1400 generate the identity corresponding to the one or more users based on the weighted plurality of features. The display controller 1400 registers the identity corresponding to the one or more users in the database, wherein registering the identity of the one or more users in the database enables at least one of identification and authentication of the one or more users, wherein the database stores identities of the plurality of authorized users.

The display controller 1400 determines that the one or more users is authorized to appear in a media associated with the at least one input image frame based on the generated identity of the one or more users matching with the at least one identity pre stored in the database. The display controller 1400 displays the plurality of pixels associated with the one or more users in the media on determining that the user is authorized to appear in the media.

In one or more embodiments, the identity corresponding to the one or more users is generated using at least one DNN model.

In one or more embodiments, the amount of information associated with the corresponding feature of the plurality of features comprises at least one of a face direction, a color of texture, a distance from camera, a focus towards camera, and a presence of obstacles in the face.

FIG. 11 is a flowchart illustrating method for displaying particular user by the electronic device 1000, according to one or more embodiments.

At step S1101, the electronic device 1000 captures the one or more input image frames including one or more users using the camera.

At step S1102, the electronic device 1000 determines the plurality of pixels associated with the one or more users.

At step S1103, the electronic device 1000 extracts the plurality of features of the one or more users based on the plurality of pixels associated with the one or more users.

At step S1104, the electronic device 1000 weights each of the plurality of features based on the amount of information associated with the corresponding feature of the plurality of features.

At step S1105, the electronic device 1000 generates the identity corresponding to the one or more users based on the weighted plurality of features.

At step S1106, the electronic device 1000 determines whether the generated identity matches with one or more identities in the database, wherein the database includes the plurality of identities associated with the plurality of authorized users

At step S1107, the electronic device 1000 display the plurality of pixels associated with the one or more users when the generated identity matches with the one or more identities in the database.

FIG. 12 is a sequence diagram illustrating the registration and recognition of the one or more users, according to one or more embodiments.

At 1201, the electronic device 1000 captures using the camera of the electronic device 1000, at least one input image frame including the one or more users.

At 1202, the electronic device 1000 determine the plurality of pixels associated with the one or more users. Further, the electronic device 1000 is configured to extract the plurality of features of the one or more users based on the plurality of pixels associated with the one or more users. Further, the electronic device 1000 is configured to weight each of the plurality of features based on the amount of information associated with the corresponding feature of the plurality of features. Further, the electronic device 1000 is configured to generate the identity corresponding to the one or more users based on the weighted plurality of features.

At 1203, the electronic device 1000 registers the identity corresponding to the one or more users in the database.

At 1204, the electronic device 1000 captures using the camera of the electronic device 1000, one or more input image frames including the one or more users.

At 1205, the electronic device 1000 determine the plurality of pixels associated with the one or more users. Further, the electronic device 1000 is configured to extract the plurality of features of the one or more users based on the plurality of pixels associated with the one or more users. Further, the electronic device 1000 is configured to weight each of the plurality of features based on the amount of information associated with the corresponding feature of the plurality of features. Further, the electronic device 1000 is configured to generate the identity corresponding to the one or more users based on the weighted plurality of features

At 1206, the electronic device 1000 determine whether the generated identity matches with one or more identities in the database 1203.

At 1207, the electronic device 1000 apply effects to the input frame when the generated identity matches with one or more identities in the database 1203.

At 1208, the electronic device 1000 display the plurality of pixels associated with the one or more users after rendering.

FIG. 13 is a diagram illustrating tracking of the registered one or more users, according to one or more embodiments.

At 1301, the electronic device 1000 captures using the camera one or more input image frames including the user facing towards the camera.

At 1302, the electronic device 1000 determines instances in the image.

In one or more embodiments, instances are referred as user and human.

At 1303, the electronic device 1000 generates the identity for the user.

At 1304, the identity is the feature vector for the user and the identity helps the electronic device 1000 to track the user. At 1305, the electronic device 1000 tracks the user based on the identity.

At 1306, the electronic device 1000 captures using the camera one or more input image frames including the user facing away from the camera.

At 1307, the electronic device 1000 determines instances in the image.

At 1308, the electronic device 1000 generates the identity for the user.

At 1309, the identity is the feature vector for the user and the identity helps the electronic device 1000 to track the user. At 1310, the electronic device 1000 tracks the user based on the identity even when the user turns away from the camera.

FIG. 14A, FIG. 14B, and FIG. 14C are diagrams illustrating determination of humans in the input frame, according to one or more embodiments.

In one or more embodiments, the electronic device 1000 automatically generates unique identity for each human in the scene. In FIG. 14A, the electronic device 1000 determines that no human is present in the input frame. In FIG. 14B, the electronic device 1000 determines the presence of one human and generates the identity for the user. In FIG. 14C, the electronic device 1000 determines the presence of two human and generates the identity for two users.

In one or more embodiments, no touch points to mark foreground and background regions are required. Further the identity is generated only for humans since it is trained with human images.

FIG. 15 is a flowchart illustrating method for identifying desired user pixels, according to one or more embodiments.

At 1501, the electronic device 1000 captures using the camera one or more input frames including the one or more users.

At 1506, the display controller is configured to segment the instances in the input frames, and at 1507, the display controller 1400 is configured to generate the identity corresponding to the one or more users based on the weighted plurality of features in the input frames.

At 1508, the display controller is configured to determine whether the generated identity matches with one or more identities in the database. At 1509, the display controller is configured to filter the instances when the generated identity matches with one or more identities in the database.

At 1503, the electronic device 1000 applies effects in the background of the input frame including, but not limited to, blur, color backdrop and Background Image.

At 1504, the electronic device 1000 blends the background image and input image frame using a filtered instance mask.

At 1505, the electronic device 1000 displays the output frame including one or more user with a correct background.

FIG. 16 is a diagram illustrating segmentation and identity entity generation, according to one or more embodiments.

At 1601, the input frame is fed into an encoder 1602, and the output of the encoder 1602 is classified into three decoders. The first decoder is the segmentation decoder 1603 that outputs the classification probability of each pixel into a human/non-human category. The output of the first decoder is a segmentation map of size H×W where H is the height and W is the width of the frame. The second decoder is an instance decoder 1604 that distinguish all the pixels belonging to foreground (human) and background classes (non-human). The segmentation output is passed back as input for the next frame and acts as guide for the next segmentation output. As no major deviations in consecutive frames, the output is temporally stable. The identity decoder 1605 provides the identity for the humans in the input frame.

In one or more embodiments, the identity decoder 1605 captures the pixel level information in a unique identity which helps to represent each human instance in the frame uniquely. The output is a map of D×F, where D is the number of human instances (unique persons) in the input image frame and F is the size of the identity entity which uniquely represents the human. The identity decoder 1605 generates D identity vectors for each image, where D is the number of unique humans in the scene and F is the length of the identity vector. Further, the identity decoder 1605 is trained such that the description of each pixel in human instance and all the important visual attributes of human instance is expressed in these F-dimension identity vectors. Further, the value of F should be big enough to represent all the variations in the human instance embedding but small enough that the model complexity does not increase (for example, F is 256).

FIG. 17 and FIG. 18 are scenarios illustrating shifting of focus across registered profiles, according to one or more embodiments.

Referring to FIG. 17, the electronic device 1000 displays two registered users 1701 and 1702 in the display. As shown in FIG. 18, the electronic device 1000 shifts the focus from one registered user 1701 to the another registered user 1702. The electronic device performs the shifting of focus using a gaze detection. The proposed system identifies where the registered user is looking and shifts the focus to the other registered user 1702 as the user is already registered.

FIG. 19 is a diagram illustrating a method to reduce a difference between model prediction and annotated ground truth of an input image 1901, according to one or more embodiments.

The instance decoder receives the input image 1901 and outputs a segmentation mask 1903 with each human cluster separated in different channels using a segmentation decoder 1902. The training of the instance decoder is done over multiple iterations where the channel wise prediction is compared with the annotated Ground Truth 1905 and difference (error) in prediction model 1903 is back propagated to update the weights of the decoder to minimize a loss between predicted and Ground Truth 1904. The network predicts all the instances and learns to separate instances in different channels.

In one or more embodiments, the instance decoder receives the input image and outputs the segmentation mask with each human cluster separated in different channels. The training of the instance decoder is done over multiple iterations where the channel wise prediction is compared with the annotated ground truth and difference (error) in prediction is back propagated to update the weights of the decoder.

FIG. 20 is a diagram illustrating identity generation based on features visualization, according to one or more embodiments.

In one or more embodiments, the electronic device 1000 focuses on few specific areas marked as attention regions 2002 based on different parts of human in an input image frame 2001. The features related to the attention regions 2002 are extracted using Identity Decoder

The attention regions 2002 are not static or preconfigured. During training of the identity decoder, the network or the electronic device 1000 learns which region or which part of body need to be given focus based on the image.

The color intensity represents the weights (W1, W2 . . . Wn) 2003 of attention region features learnt by the Identity decoder. The weights varies for different part of human body based on pose or appearance variation in the input frame 2001). The attention with maximum intensity represented as red area that is the learned feature vector extracted from this region is being given more focus (weight, W1 W2 . . . Wn) towards these areas by the identity decoder.

In one or more embodiments, attention with minimum intensity is given less focus and represented in blue color. Less focus and weight is given to features that is very hard to distinguishable feature (for example, hands of two different person or when face is not visible).

In one or more embodiments, the identity is otherwise referred as identity entity.

In one or more embodiments, the identity entity 2004 is a float vector for each human in the input frame. The float vector is determined by the Identity decoder. The float vector represent the weighted combination of all features extracted from the attention regions for the human in the input frame.

FIG. 21 is a flowchart illustrating training of identity decoder module, according to one or more embodiments.

At S2101, the electronic device 1000 collect samples of multiple person in multiple visual variations. The variations includes, but not limited to, appearance variation, pose variation, scale variation and other variations. The electronic device 1000 is otherwise referred as network.

At S2102, the electronic device 1000 prepares data packets with positive and negative samples.

At S2103, the electronic device 1000 initializes a neural network with random weights.

At S2104, the electronic device 1000 provides millions of data packets and generate the output identity vectors from the neural network.

At S2105, the electronic device 1000 compares with ground truth identity vectors and using learning method of neural network, update the weights of the network to predict better identity vectors.

At S2106, the electronic device 1000 performs identity decoder.

FIG. 22 is a diagram illustrating data packets containing samples from the database for giving inputs to the identity decoder module, according to one or more embodiments.

In one or more embodiments, data packets containing two samples of same person and one sample from different person are collected from the database and given as inputs to the identity decoder module. At 2201, the proposed system collect samples of multiple person in multiple visual variations during database collection phase. At 2202, the proposed system create visual pairs of same person as a positive samples. At 2203, the proposed system create visual pair with different persons as a negative samples. At 2204, the proposed system create data packet with one positive and one negative sample during data pre-processing phase.

FIG. 23A, FIG. 23B, FIG. 23C, and FIG. 23D are diagrams illustrating different attention regions and different weighted combination for appearance variation, according to one or more embodiments.

In one or more embodiments, the data packet is a set of 3 images representing a single training example used for Identity decoder training. It consists of 2 images of same person in different variations and 1 image of different person. The Identity decoder is a convolution based neural network that takes in the data packet and outputs identity vectors for all persons in all images in the data packet and improves the prediction over multiple training examples.

In one or more embodiments, the ideal output needs to ensure minimum variation across identity vectors belonging to same person and maximum variation across identity vectors belonging to different person.

In one or more embodiments, the predicted identity vectors from the data packet are clustered in same cluster or different cluster based on whether the identity vector represent same person or different person. The contrastive loss function ensures that the predicted identity vectors come closer to the ideal identity vector prediction with each training example.

FIG. 23A, FIG. 23B, FIG. 23C, and FIG. 23D represent different training examples of data packets. As the training should be done across multiple appearance variations of same and different person, so that the network learns from a variety of data.

The FIG. 23A shows different body color variations of all persons. The FIG. 23B shows focuses on face variations and available face details—with and without mask for all the persons. The FIG. 23C highlights different pose variations—facing camera and facing away from camera for the humans in scene. The FIG. 23D shows again pose variations—standing near and standing far from camera for the humans. The FIG. 23A, FIG. 23B, FIG. 23C, and FIG. 23D are examples shows the variety required for the dataset to generalize to any random scene for the decoder.

FIG. 24 is a diagram illustrating manual registration of the one or more users, according to one or more embodiments.

At 2401, the electronic device 1000 captures one or more input image frames including a plurality of users using the camera. At 2402, when the captured image frame comprises more than one users, user can click on desired person for registration. At 2403, the electronic device 1000 segments the plurality of pixels associated with the one or more users from the one or more input image frames. At 2404, the electronic device 1000 generates the identity for the user based on the weighted plurality of features. At 2405, the electronic device 1000 stores the generated identity in the database, where the database includes the plurality of identities associated with the plurality of authorized users.

FIG. 25 is a diagram illustrating automatic registration of the one or more users, according to one or more embodiments.

At 2401, the electronic device 1000 captures one or more input image frames including the plurality of users using the camera.

At 2501, the electronic device 1000 automatically selects the one or more users for registration based on the depth of the user in the input frame when the captured image frame comprises more than one users.

At 2502, the electronic device 1000 automatically selects the one or more users for registration based on the size of the face of the users in the input frame when the captured image frame comprises more than one users. The largest face is selected.

At 2403, the electronic device 1000 segments the plurality of pixels associated with the one or more users from the one or more input image frames. At 2404, the electronic device 1000 generates the identity for the user based on the weighted plurality of features. At 2405, the electronic device 1000 stores the generated identity in the database.

FIG. 26 is a diagram illustrating a suggestion based registration of the one or more users, according to one or more embodiments.

At 2401, the electronic device 1000 captures one or more input image frames including the plurality of users using the camera.

At 2501, the electronic device 1000 automatically selects the one or more users for registration based on the depth of the user in the input frame when the captured image frame comprises more than one users.

At 2502, the electronic device 1000 automatically selects the one or more users for registration based on the size of the face of the users in the input frame when the captured image frame comprises more than one users.

At 2601, the electronic device 1000 suggest one or more users in the display based on the selection. When the user selects the suggested user, the electronic device 1000 consider the suggestion user for registration.

At 2403, the electronic device 1000 segments the plurality of pixels associated with the selected users from the one or more input image frames. At 2404, the electronic device 1000 generates the identity for the user based on the weighted plurality of features. At 2405, the electronic device 1000 stores the generated identity in the database.

FIG. 27 is a flowchart illustrating registration process using identity entity generator, according to one or more embodiments.

At 2701, the electronic device 1000 receives the input frame.

At 2702, the electronic device 1000 triggers desired user selection using multimodal cues including, but not limited to, voice, depth from camera, gazing, largest instance and even largest face. When the desired user is confirmed then we will enter registration mode for the user.

At 2703, the electronic device 1000 exit the process when the desired user is not present in the input frame.

At 2704, the electronic device 1000 performs instance segmentation, and At 2705, the electronic device 1000 extracts the pixels belonging to the desired users and generates unique Identity entity for each user and prepares it for storage.

At 2707, the electronic device 1000 stores the Identity entity in the database.

At 2708, the electronic device 1000 renders a desired effect required and creates the background frame.

At 2709, the electronic device 1000 uses pixels of the registered person and blends background frame and input image to create a final rendered frame using a bending module.

At 2710, the electronic device 1000 display and register the final rendered frame.

FIG. 28 is a flowchart illustrating an automatic instance recognition and filtering based on registered user, according to one or more embodiments.

At 2801, the electronic device 1000 receives the input frame.

At 2803, the electronic device 1000 performs instance segmentation, and At 2802, the electronic device 1000 extracts the pixels belonging to the desired users and generates unique identity entity for each user.

At 2804, the electronic device 1000 matches generated identity entity generated against the registered one or more identity entities.

At 2806, the electronic device 1000 removes and filter out all unregistered pixels and the registered identity entities are retained

At 2807, the electronic device 1000 renders a desired effect required and creates the background frame.

At 2808, the electronic device 1000 uses pixels of the registered person and blends background frame and input image to create a final rendered frame using a bending module.

At 2809, the electronic device 1000 display and register the final rendered frame.

FIG. 29 is a diagram illustrating registration of one or more user and matching the input image frame with the register user, according to one or more embodiments.

Referring to the FIG. 29, the proposed method relies on generating and matching feature vectors derived from all the pixels belonging to the registered user. This includes facial as well as information indicating non-facial cues generated from the human instance.

The electronic device 1000 determine whether the generated identity matches with one or more identities in the database 1203, where the identities in the database 1203 are registered identities.

Therefore, unlike to the related art methods and systems which rely heavily on facial features, the embodiments herein can go by human instances which include both the facial and the information indicating non-facial cues.

FIG. 30 is a diagram illustrating weighting of the one or more users and matching the input image frame with the register user, according to one or more embodiments.

In one or more embodiments, at time t, the user has registered himself where face information is properly visible. The identity entity generated will have weighted features from face, clothes, pose and other Identity related cues. After few frame (t+k), even if the face information is not visible in the image, the Identity generated will have weighted features from clothes, pose and other Identity related cues from the same person. The Identity matcher 1404 is still able to match the Identity generated at time t+k to the Identity generated at time t because the Identity features use a weighted combination of facial and non-facial information. Thus without facial information, the embodiments herein recognize the registered user in the scene based on the user's other identity related features.

In one or more embodiments, the identity features is contributed by, but not limited to, face pixels, body cloth pixels and hand pixels. When no face is visible, the identity features is contributed by body cloth pixels and hand pixels. Thus the embodiments herein are able to find match to registered ID in absence of face features due to similarity of other features of the human.

FIG. 31 is a diagram illustrating a method for applying bokeh in the input image frame for the non-registered user, according to one or more embodiments.

Referring to the FIG. 31, at step 3101, the camera captures an input instance 3106 including multiple users. At step 3102, the electronic device 1000 performs instance detection and the feature vector generator generates the identity feature vector. At step 3103, the electronic device 1000 performs feature vector matching against the user profile. At step 3104, the electronic device 1000 filters the remaining instances and at step 3105, the electronic device 1000 applies Bokeh effect. The final output is displayed as provided in step 3107.

FIG. 32 is a diagram illustrating auto focus based on person of interest, according to one or more embodiments.

Referring to the FIG. 32, at step 1, original video can be captured with all-in-focus mode and at step 2, while sharing with different users, each video can apply auto blur based on the person-of-interest in their registered list. For example, three different videos can be auto-created keeping each kid in focus and shared with their respective parents who have added their kid in the registered list. Further, auto clipping can be applied to cut portions having person of interest in the frames and discard other frames.

The proposed method can also be used for portrait video focus shifting across registered profiles. The focus in a video is shifted to the user whose profile is registered in the electronic device 1000 and all other users in the video can be blurred automatically.

FIG. 33 is a diagram illustrating hiding of background details for the registered user using blur/background effect, according to one or more embodiments.

In one or more embodiments, the input frame 3301 is captured by the electronic device 1000 in crowded places, where many humans in the background and they can come in focus by mistake during important Video Call meetings. The proposal system can apply blur 3302 and color 3303 to keep only the registered user in focus and all the background details is be hidden using Blur/Background effect. Thus user can now take meetings anyplace and anytime without worrying about the background using the proposed system.

FIG. 34 is a diagram illustrating a personalization of gallery photos, according to one or more embodiments.

Referring to the FIG. 34, at step 3401, a photo including multiple users with a background person is available in the gallery of the electronic device 1000. In the proposed method, the photo personalization can be performed using registered users. Here, in the step 3402, the electronic device 1000 removes the background persons automatically to show only registered user profiles.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of example embodiments, those skilled in the art will recognize that the embodiments herein can be practiced with modification within the scope of the embodiments as described herein.

What is claimed is:

1. A method for displaying a particular user and being performed by an electronic device, the method comprising:
capturing, using a camera of the electronic device, at least one input image frame including at least one user;
determining, from the at least one input image frame, a plurality of pixels associated with the at least one user;
extracting a plurality of features of the at least one user based on the plurality of pixels associated with the at least one user;
weighting each of the plurality of features based on an amount of information corresponding each of the plurality of features;
generating identity information corresponding to the at least one user based on the weighted plurality of features;
determining whether the generated identity information matches at least one identity information stored in a database, wherein the at least one identity information comprises a plurality of identities associated with a plurality of authorized users; and
displaying the plurality of pixels associated with the at least one user based on determining that the generated identity information matches the at least one identity information in the database.

2. The method as claimed in claim 1, further comprising performing a function corresponding to at least one of masking, filtering, and blurring the plurality of pixels associated with the at least one user based on determining that the generated identity information does not match the at least one identity information in the database.

3. The method as claimed in claim 1, wherein the plurality of features comprises at least one of information, indicating facial cues associated with the at least one user, and information indicating non-facial cues associated with the at least one user.

4. The method as claimed in claim 3, wherein the at least one of the information, indicating facial cues associated with the at least one user, and the information, indicating non-facial cues associated with the at least one user, comprises at least one of clothing, color, texture, style, body size, hair, face, pose, position, and viewpoint.

5. The method as claimed in claim 1, wherein displaying the plurality of pixels associated with the at least one user, comprises:
determining at least one output image frame for displaying the plurality of pixels associated with the at least one user;
determining at least one visual effect to be applied to the at least one output image frame;
determining at least one background frame using the at least one visual effect;
determining at least one modified output image frame by merging the at least one output image frame and the at least one background frame; and
displaying the at least one modified output image frame.

6. The method as claimed in claim 1, wherein determining the plurality of pixels associated with the at least one user, comprises:
segmenting the plurality of pixels associated with the at least one user from the at least one input image frame; and
generating at least one pixel map including the segmented plurality of pixels associated with the at least one user.

7. The method as claimed in claim 1, further comprising:
capturing, using the camera of the electronic device, at least one input image frame including the at least one user;
selecting the at least one user based on at least one of user selection, size of face of the at least one user, distance of the at least one user from the electronic device and suggestions for selection;
determining the plurality of pixels associated with the selected at least one user;
extracting the plurality of features of the at least one user based on the plurality of pixels associated with the at least one user;
weighting each of the plurality of features based on the amount of information associated with the corresponding feature of the plurality of features;
generating the identity information corresponding to the at least one user based on the weighted plurality of features; and
registering the identity information corresponding to the at least one user in the database, wherein registering the identity information of the at least one user in the database enables at least one of identification and authentication of the at least one user, wherein the database stores identities of the plurality of authorized users.

8. The method as claimed in claim 1, further comprising:
determining that the at least one user is authorized to appear in a media associated with the at least one input image frame based on the generated identity information of the at least one user matching with the at least one identity information in the database; and
displaying the plurality of pixels associated with the at least one user in the media on determining that the user is authorized to appear in the media.

9. The method as claimed in claim 1, wherein the identity information corresponding to the at least one user is generated using at least one deep neural network (DNN) model.

10. The method as claimed in claim 1, wherein the amount of information associated with the corresponding feature of the plurality of features comprises at least one of a face direction, a color of texture, a distance from camera, a focus towards camera, and a presence of obstacles in the face.

11. An electronic device for displaying particular user, the electronic device comprising:
a memory;
a processor;
a display controller coupled with the memory and the processor, configured to:
capture, using a camera, at least one input image frame including at least one user;
determine, from the at least one input image frame, a plurality of pixels associated with the at least one user;
extract a plurality of features of the at least one user based on the plurality of pixels associated with the at least one user;
weight each of the plurality of features based on an amount of information corresponding each of the plurality of features;
generate identity information corresponding to the at least one user based on the weighted plurality of features;
determine whether the generated identity information matches with at least one identity information stored in a database, wherein the at least one identity information comprises a plurality of identities associated with a plurality of authorized users; and
display the plurality of pixels associated with the at least one user based on the generated identity information matching with the at least one identity information in the database.

12. The electronic device as claimed in claim 11, wherein the processor is further configured to perform a function corresponding to at least one of masking, filtering, and blurring the plurality of pixels associated with the at least one user based on determining that the generated identity information does not match the at least one identity information in the database.

13. The electronic device as claimed in claim 12, wherein the identity information is a feature vector.

14. The electronic device as claimed in claim 12, wherein the plurality of features comprises at least one of information, indicating facial cues associated with the at least one user, and information indicating non-facial cues associated with the at least one user.

15. The electronic device as claimed in claim 14, wherein the at least one of the information, indicating facial cues associated with the at least one user, and the information, indicating non-facial cues associated with the at least one user, for determining the plurality of features comprises at least one of clothing, color, texture, style, body size, hair, face, pose, position, and viewpoint.
